(19) United States
(12) Patent Application Publication
(10) Pub. No.: US 2015/0377204 A1
(43) Pub. Date: Dec. 31, 2015

(54) VEHICULAR ELECTRONIC CONTROL UNIT

(71) Applicant: DENSO CORPORATION, Kariya-city (JP)

(72) Inventor: Yutaka KOYAMA, Toyoake-city (JP)

(21) Appl. No.: 14/729,625

(22) Filed: Jun. 3, 2015

(30) Foreign Application Priority Data
Jun. 27, 2014 (JP) 2014-133117

(51) Int. Cl. F02P 5/15

(52) U.S. Cl. CPC F02P 5/1518

(57) ABSTRACT

A vehicular electronic control unit is provided that includes a first microcomputer equipped with an ignition power related function and a second microcomputer equipped with a battery power related function. The first microcomputer executes the ignition power related function to monitor an operation of the second microcomputer and to make the second microcomputer monitor an operation of the first microcomputer. The second microcomputer executes the battery power related function to monitor the operation of the first microcomputer and to make the first microcomputer monitor an operation of the second microcomputer. The first microcomputer includes a monitoring unit that monitors the operation of the second microcomputer in accordance with generation of a starting factor before turn on of an ignition switch.

### CROSS REFERENCE TO RELATED APPLICATION

The present application is based on Japanese Patent Application No. 2014-133117 filed on Jun. 27, 2014, disclosure of which is incorporated herein by reference.

### TECHNICAL FIELD

The present disclosure relates to a vehicular electronic control unit including multiple microcomputers.

### BACKGROUND

There is a technology that integrates multiple functions in a single vehicular electronic control unit, as disclosed in Patent Literature 1.

Patent Literature 1: JP-2013-1141A

The following describes background information which does not necessarily constitute prior art.

It is conceivable that a vehicular electronic control unit includes multiple microcomputers to integrate functions that are different in power supply system between a BATT power supply system and an IG power supply system. Specifically, this vehicular electronic control unit includes a first microcomputer equipped with a function of an IG power supply system and a second microcomputer equipped with a function of a BATT power supply system. The function of the IG power supply system is defined as a function that is executed in accordance with ON of an IG switch and is stopped in accordance with OFF of the IG switch. The function of the BATT power supply system is defined as a function that is executed in accordance with a starting factor other than the IG switch and is stopped in accordance with the stop of the starting factor. Additionally, the function of the BATT power supply system is executed earlier than the function of the IG power supply system and is stopped later than the function of the IG power supply system. Therefore, the second microcomputer starts earlier than the first microcomputer and stops later than the first microcomputer. In the present disclosure, the IG is an abbreviation of an ignition switch.

It is also conceivable that the first microcomputer and the second microcomputer of the vehicular electronic control unit mutually monitor operations each other, i.e., perform mutual monitoring. However, in the vehicular electronic control unit, the first microcomputer and the second microcomputer are different in start timing. Accordingly, the vehicular electronic control unit may have a non-monitored state in which the operation of the second microcomputer is not monitored. Specifically, the second microcomputer is in the non-monitored state during a period from the start of the second microcomputer to the turn on of the IG switch and during a period from the turn off of the IG switch to the stop of the second microcomputer.

### SUMMARY

The present disclosure is made in view of the foregoing. It is an object of the present disclosure to provide a vehicular electronic control unit that can prevent occurrence of a non-monitored state of a microcomputer.

A vehicular electronic control unit according to an example comprises: a first microcomputer that is equipped with an ignition power related function that is executed in accordance with turn on of an ignition switch and stopped in accordance with turn off of the ignition switch; and a second microcomputer that is equipped with a battery power related function that is executed in accordance with generation of a starting factor and stopped in accordance with stop of the starting factor. The starting factor is a starting factor that is generated before the turn on of the ignition switch and stopped after the turn off of the ignition switch. The first microcomputer includes: a first monitoring unit that, in executing the ignition power related function, monitors an operation of the second microcomputer; and a first monitored unit that, in executing the ignition power related function, makes the second microcomputer monitor an operation of the first microcomputer. The second microcomputer includes: a second monitoring unit that, in executing the battery power related function, monitors the operation of the first microcomputer; and a second monitored unit that, in executing the battery power related function, makes the first microcomputer monitor the operation of the second microcomputer. The first microcomputer is equipped with, in addition to the ignition power related function, a third monitoring unit that monitors the operation of the second microcomputer in accordance with the generation of the starting factor.

According to the above configuration, the vehicular electronic control unit comprises the first microcomputer including the first monitoring unit and the first monitored unit and the second microcomputer including the second monitoring unit and the second monitored unit. Therefore, the first microcomputer and the second microcomputer can mutually monitor their operations. Furthermore, the first microcomputer includes the third monitoring unit that monitors the operation of the second microcomputer in accordance with the generation of the starting factor. Therefore, even during a period during which the ignition switch is off and the starting factor is generated, the first microcomputer can monitor the second microcomputer. An occurrence of a non-monitored state of the second microcomputer is prevented.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating an outline configuration of an HV-ECU in an embodiment;

FIG. 2 is a flowchart illustrating processing of an HV-ECU in an embodiment; and

FIG. 3 is a time chart illustrating processing of an HV-ECU in an embodiment.

### DETAILED DESCRIPTION

Embodiments will be described with reference to the drawings.

In the present embodiment, a vehicular electronic control unit is applied to a HV-ECU 100, which is an abbreviation of a hybrid vehicle electronic control unit. Thus, the present embodiment concerns a vehicular electronic control unit mounted to a hybrid vehicle. It is however noted that a vehicular electronic control unit is applicable to other electronic control units mounted to a vehicle. In the following, the HV-ECU 100 may be also referred to as an ECU 100.

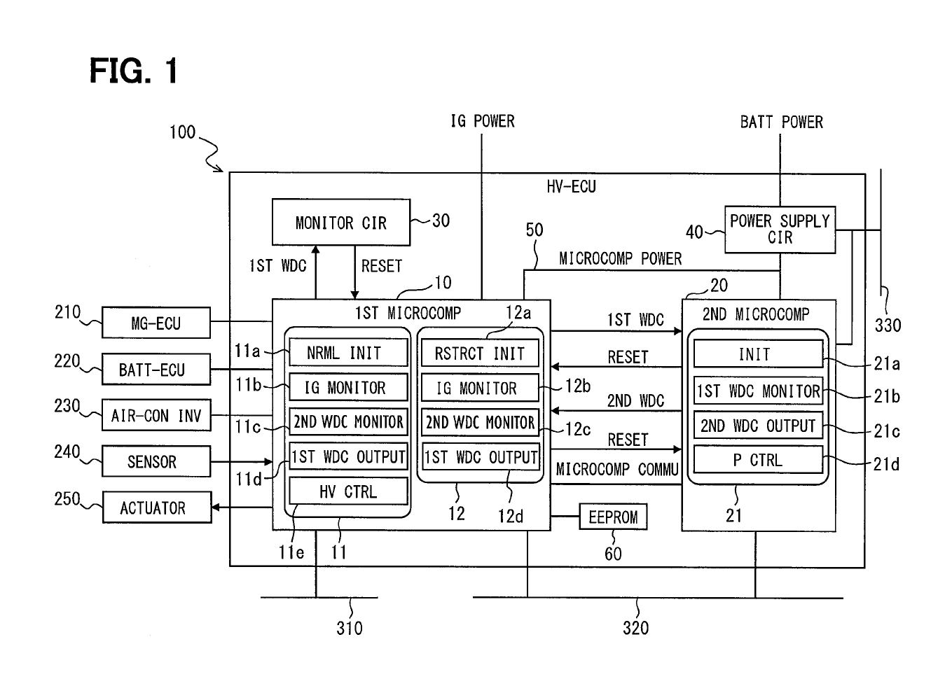

First, a configuration of the ECU 100 will be described with reference to FIG. 1. The ECU 100 includes a first microcomputer 10, a second microcomputer 20, a monitor circuit 30, a power supply circuit 40, a microcomputer power supply path 50, an EEPROM 60 etc. The ECU 100 is connected with a MG-ECU 210, a battery ECU 220, an air-conditioner INV 230, a sensor 240, and an actuator 250. The ECU 100 is connected to a first communication bus 310, a second communication bus 320, and a third communication bus 330. Through these buses 310 to 330, the ECU 100 can perform communications. The EEPROM is the registered trade mark.

In one example, the ECU 100 uses a CAN communication protocol to perform communications through the first communication bus 310 and the second communication bus 320, and uses a LIN communication protocol to perform communications through the third communication bus 330. In this case, the first communication bus 310 can be referred to as a first CAN bus, the second communication bus 320 can be referred to as a second CAN bus, and the third communication bus 330 can be referred to as a LIN bus. The CAN is the registered trade mark.

Each of the first microcomputer 10 and the second microcomputer 20 includes a CPU, a ROM, a RAM, a register, an I/O, etc. In each of the first microcomputer 10 and the second microcomputer 20, the CPU executes signal processing in accordance with a control program or various data pre-stored in the ROM or various data acquired via the buses 310 to 330 while using a temporary storage function of the register or the RAM. Moreover, each of the first microcomputer 10 and the second microcomputer 20 outputs a signal obtained in the signal processing by the communication between the microcomputers and outputs the signal to the buses 310 to 330. Through the above manners, each of the first microcomputer 10 and the second microcomputer 20 executes various functions. The CPU is an abbreviation of the central processing unit. The ROM is an abbreviation of the read only memory. The RAM is an abbreviation of the random access memory. The I/O is an abbreviation of the input/output.

Now, the first microcomputer 10 and the second microcomputer 20 will be described individually. First, the second microcomputer 20 will be described.

The second microcomputer 20 is equipped with a BATT task. The second microcomputer 20 executes the BATT task when being supplied with electric power from the power supply circuit 40. The BATT task 21 is started when a starting factor is inputted from the third communication bus 330, and is terminated when the starting factor is stopped. The BATT task 21 is a function that is executed in accordance with a starting factor other than the IG switch and is terminated in accordance with the stop of the starting factor. The starting factor of the BATT task 21 can correspond to a starting factor in the present disclosure. The BATT task 21 is also referred to as a BAIT related starting factor in order to be distinguished from the below-described IG related starting factor. The IG switch can correspond to an ignition switch in the present disclosure.

The BATT related starting factor is generated earlier than the IG switch is changed from off to on. After the IG switch is changed from on to off, the BATT related starting factor is stopped. Accordingly, the second microcomputer 20 starts executing the BATT task 21 before the IG switch is changed from off to on. After the IG switch is changed from on to off, the second microcomputer 20 terminates executing the BATT task 21. The BATT task 21 can correspond to a battery power related function. It is noted that the function of the battery power supply refers to the same function as the battery power related function refers to.

The second microcomputer 20 is connected to the power supply circuit 40 in order to execute the BAIT task 21. This power supply circuit 40 is connected to battery power. The battery power is electric power that is supplied not via the IG switch nor via a relay. That is, the power supply circuit 40 is directly connected to a battery. In the drawings, the battery power is shown as BATT POWER.

The power supply circuit 40 is connected to the third communication bus 330. The power supply circuit 40 is connected to the first microcomputer 10 and the second microcomputer 20 via the microcomputer power supply path 50. In response to input of the BATT related starting factor from the third communication bus 330, the power supply circuit 40 starts supplying the electric power. When the input of the BAIT related starting factor is stopped, the power supply circuit 40 stops supplying the electric power. The electric power supplied by the power supply circuit 40 is also called herein microcomputer power.

In response to the input of the BATT related starting factor to the power supply circuit 40, the second microcomputer 20 starts being supplied with the microcomputer power from the power supply circuit 40. The second microcomputer 20 continues being supplied with the microcomputer power during the input of the BATT related starting factor. In response to the stop of the input of the BATT related starting factor to the power supply circuit 40, the second microcomputer 20 stops being supplied with the microcomputer power from the power supply circuit 40. That is, the second microcomputer 20 starts being supplied with the microcomputer power before the IG switch is changed from off to on. After the IG switch is changed from on to off, the second microcomputer 20 stops being supplied with the microcomputer power. Through the above manners, the second microcomputer 20 can execute the BATT task 21.

The third communication bus 330 is connected with, for example, a body ECU, a sensor etc. The sensor detects opening and closing of a vehicle door. A door opening signal, a collation establishment signal, a key unlock signal etc. are inputted to the second microcomputer 20 and the power supply circuit 40 through the third communication bus 330. The door opening signal is a signal representing that the closed door of the hybrid vehicle is opened. The collation establishment signal is a signal representing that collation between the hybrid vehicle and a card key is established. The key unlock signal is a signal representing that the door is unlocked. These signals are generated before the IG switch is turned on. After the IG switch is turned off, the signals are stopped. Therefore, these signals can be adopted as the BATT related starting factor. It is noted that the BATT related starting factor may be limited to these signals. In one embodiment, the door opening signal is adopted as the BATT related starting factor for example.

The BATT task 21 includes functions of an initialization process 21a, a first WDC monitoring process 21b, a second WDC output process 21c and a P control process 21d.

The first WDC monitoring process 21b monitors an operation of the first microcomputer 10. The first WDC monitoring process 21b can correspond to a second monitoring means and a second monitoring unit. Specifically, the first WDC monitoring process 21b acquires a first WDC outputted from the first microcomputer 10, and determines whether the first microcomputer 10 is normally operating based on this first WDC. When it is determined that the first microcomputer 10 is not normally operating, the first WDC monitoring process 21b resets the first microcomputer 10. The WDC is an abbreviation of a watch dog counter.

The second WDC output process 21c outputs a second WDC representing that the second microcomputer 20 is normally operating. The second WDC output process 21c causes the first microcomputer 10 to monitor an operation of the second WDC output process 21c. In other words, the second WDC output process 21c makes the first microcomputer 10 monitor an operation of the second WDC output process 21c and an operation the second microcomputer 20. The second WDC output process 21c can correspond to a second monitored means and a second monitored unit. The second WDC is a signal for monitoring called also a monitoring signal. For example, a pulse signal etc. can be used as the second WDC. Therefore, it can be described that the second microcomputer 20 outputs the monitoring signal to the first microcomputer 10.

The P control process 21d executes parking lock control of the hybrid vehicle. In one embodiment, the P control process 21d is included in the BATT task 21. However, embodiments are not limited to this. The BATT task 21 may include a process for executing approach notification control. The BATT task 21 may include functions weakly relating to travel of the hybrid vehicle.

The initialization process 21a initializes all function of the microcomputer needed to perform the above processes 21b to 22d and initializes hardware needed to perform the above processes 21b to 22d. In other words, the initialization process 21a initializes all needed to execute the above processes 21b to 22d. In the above, the hardware includes a circuit element of the ECU 100.

Now, the first microcomputer 10 will be described.

The first microcomputer 10 is equipped with a normal task 11 and a special task 12 independent of each other. The first microcomputer 10 executes the normal task 11 when the IG switch is on. The first microcomputer 10 executes the special task 12 when being supplied with the below-described microcomputer power.

The normal task 11 is started in response to a change of the IG switch from off to on and is terminated in response to a change of the IG switch from on to off. In order to execute the normal task 11, the first microcomputer 10 is connected to IG power. The IG power is electric power that is supplied via the IG switch and is linked to an operation of the IG switch. Thus, in response to a change of the IG switch from off to on, the first microcomputer 10 starts being supplied with the electric power. During the on of the IG switch, the first microcomputer 10 continues being supplied with the electric power. In response to a change of the IG switch from on to off, the first microcomputer 10 stops being supplied with the electric power.

Specifically, in response to a change of the IG switch from off to on, the first microcomputer 10 starts executing the normal task 11. In response to a change of the IG switch from on to off, the first microcomputer 10 terminates executing the normal task 11. Thus, the starting factor of the normal task 11 includes the on of the IG switch. The starting factor of the normal task 11 is also referred to as an IG related starting factor. This normal task 11 can correspond to an ignition power related function. As can be seen in the above, in the ECU 100, the ignition power related function and the battery power related function are separately equipped in different microcomputers, i.e., the first microcomputer 10 and the second microcomputer 20.

The normal task 11 has functions of an initialization process 11a, an IG monitor process 11b, a second WDC monitor process 11c a first WDC output process 11d, and a HV control process 11e.

The IG monitor process 11b monitors a voltage of the IG power in order to detect switch-over timing from the normal task 11 and the special task 12. Specifically, the IG monitor process 11b determines whether or not the IG switch is changed from on to off based on the voltage of the IG power. When it is determined that the IG switch is changed from on to off, the IG monitor process 11b considers this change as the switch over timing from the normal task 11 to the special task 12.

The second WDC monitor process 11c monitors an operation of the second microcomputer 20. The second WDC monitor process 11c can correspond to a first monitor means and a first monitoring unit. The second WDC monitor process 11c acquires the second WDC outputted from the second microcomputer 20 and determines whether or not the second microcomputer 20 is normally operating based on this second WDC. When it is determined that the second microcomputer 20 is not normally operating, the second WDC monitor process 11c resets the second microcomputer 20.

The first WDC output process 11d outputs a first WDC representing that the first microcomputer 10 is normally operating. The first WDC output process 11d makes the second microcomputer 20 monitor an operation of the first WDC output process 11d and an operation of the second microcomputer 20. The first WDC output process 11d can correspond to a first monitored means and a first monitored unit. Like the second WDC, the first WDC is a signal for monitoring also called a monitoring signal. Thus, the first microcomputer 10 outputs the monitoring signal to the second microcomputer 20.

The HV control process 11e executes hybrid vehicle travel control in an integrated manner. In order for the hybrid vehicle to travel in the most efficient way, the HV control process 11e integrally controls a drive system of the hybrid system as a whole, by executing interactive management between the ECU 100 and the MG-ECU 210 and between the battery ECU 220 and the air-conditioner INV 230. The HV control process 11e executes the control by using a detection signal from the sensor 240 and data stored in the EEPROM 60 in addition to signals acquired from the MG-ECU 210, the battery ECU 220 and the air-conditioner INV 230. It is possible that the HV control process 11e may output a drive signal to the actuator 250 in integrally controlling the drive system of the hybrid system as a whole.

The initialization process 11a initializes all function of the microcomputer needed to perform the above processes 11b to 22e and initializes hardware needed to perform the above processes 11b to 22e. In other words, the initialization process 11a initializes all needed to execute the above processes 11b to 22e.

As described above, the first microcomputer 10 is equipped with functions of the travel control of the hybrid vehicle. The travel control of the hybrid vehicle is a highly-important function relating to the traveling. Thus, high operation reliability of the first microcomputer is desired. In view of this, the ECU 100 includes the monitor circuit 30 for monitoring the operation of the first microcomputer 10, so that the operation of the first microcomputer 10 is monitored by a duplex surveillance system, i.e., by the second microcomputer 20 and the monitor circuit 30. Therefore, the first WDC output process 11d outputs the first WDC to the monitor circuit 30 as well as to the second microcomputer 20.

The monitor circuit 30 acquires the first WDC outputted from the first microcomputer 10, and monitors whether the first microcomputer 10 is normally operating based on this first WDC. When it is determined that the first microcomputer 10 is not normally operating, the monitor circuit 30 resets the first microcomputer 10. Therefore, when the first microcomputer 10 is not normally operating, the first microcomputer 10 is reset by at least one of the monitor circuit 30 or the second microcomputer 20.

The special task 12 is started in response to the supply of power from the power supply circuit 40. As described above, the power supply circuit 40 starts supplying the microcomputer power in response to the input of the BATT related starting factor. Therefore, even during the off of the IG switch, the input of the BATT related starting factor to the power supply circuit 40 enables the supply of the microcomputer power from the power supply circuit 40 and enables the execution of the special task 12. In other words, the first microcomputer 10 starts executing the special task 12 in accordance with the generation of the BATT related starting factor. Therefore, the starting factor of the special task 12 includes the BATT related starting factor.

The first microcomputer 10 is equipped with the normal task 11 and the special task 12 independent of each other. It may be preferable that the first microcomputer 10 be configured not to execute the special task 12 when the normal task 11 is in execution and be configured not to execute the normal task 11 when the special task 12 is in execution. In other words, it may be preferable that the first microcomputer 10 be prohibited from executing the special task 12 during the on of the IG switch, and that the first microcomputer 10 be prohibited from executing the normal task 11 during the generation of the BATT related starting factor. Because of this, the ECU 100 can prevent malfunction of the hybrid vehicle and the like. That is, it may be preferable that the HV control process 11e, which is to be executed in accordance with the on of the IG switch, be stopped during the period of the off of the IG switch by the first microcomputer 10.

The special task 12 includes a restricted initialization process 12a, an IG monitor process 12b, a second WDC monitor process 12c, and a first WDC output process 12d.

The IG monitor process 12b monitors the voltage of the IG power in order to detect switchover timing from the special task 12 to the normal task 11. That is, based on the voltage of the IG power, the IG monitor process 12b determines whether or not the IG switch is changed from off to on. In other words, based on whether the voltage of the IG power exceeds a threshold, the IG monitor process 12b determines the presence or absence of the IG related starting function. When it is determined that the IG switch is changed from off to on, the IG monitor process 11b considers this as the switchover timing from the special task 12 to the normal task 11. It is noted that the IG monitor process 12b may not be executed.

The second WDC monitor process 12c monitors the operation of the second microcomputer 20 like the second WDC monitor process 11c. However, the second WDC monitor process 12c is executed in response to the supply of the microcomputer power from the power supply circuit 40. That is, the second WDC monitor process 12c is executed in accordance with the generation of the BATT related starting factor. In this way, the first microcomputer 10 monitors the operation of the second microcomputer 20 in accordance with the generation of the BATT related starting factor. Therefore, even during the off of the IG switch, the first microcomputer 10 monitors the operation of the second microcomputer 20 while the second microcomputer 20 is executing the BATT task 21. The second WDC monitor process 12c can correspond to a third monitor means and a third monitoring unit.

Like the first WDC output process 11d, the first WDC output process 12d outputs the first WDC representing that the first microcomputer 10 is normally operating. However, the first WDC output process 12d is executed in response to the supply of the microcomputer power from the power supply circuit 40. That is, the first WDC output process 12d is executed in accordance with the generation of the BATT related starting factor. In this way, the first microcomputer 10 makes the operation of the first microcomputer 10 itself monitored in accordance with the generation of the BATT related starting factor. Therefore, while the second microcomputer 20 is executing the BATT task 21, the first microcomputer 10 makes the operation of the first microcomputer 10 itself monitored even during the off of the IG switch. It is noted that other embodiments may not execute the first WDC output process 12d.

The restricted initialization process 12a can correspond to an initialization means or an initialization unit. The restricted initialization process 12a is an initialization process that is executed in accordance with the generation of the BATT related starting factor. The restricted initialization process 12a initializes only the followings: microcomputer functions needed to perform the above processes 12b to 12d; and hardware needed to perform the processes 12b to 12d. Specifically, only initialization needed to perform the above processes 12b to 12d is executed by the restricted initialization process 12a. In other words, the ECU 100 makes the first microcomputer 10 to operate by restricting functions of the first microcomputer 10 to the necessary functions.

Through the above manner, during the period of the off of the IG switch, execution of a microcomputer function unneeded to execute the special task 12 and driving of a circuit element unneeded to execute the special task 12 can be prevented by the first microcomputer 10. Therefore, the ECU 100 can reduce a dark current during a period during which the IG switch is off and the BATT related starting factor is generated. In other words, the ECU 100 can execute the special task 12 while suppressing the dark current.

In another embodiment, the restricted initialization process 12a may execute only initialization needed for the second WDC monitor process 12c. In this configuration also, the first microcomputer 10 can monitor the operation of the second microcomputer 20 during a period during which the IG switch is off and the second microcomputer 20 is executing the BATT task 21.

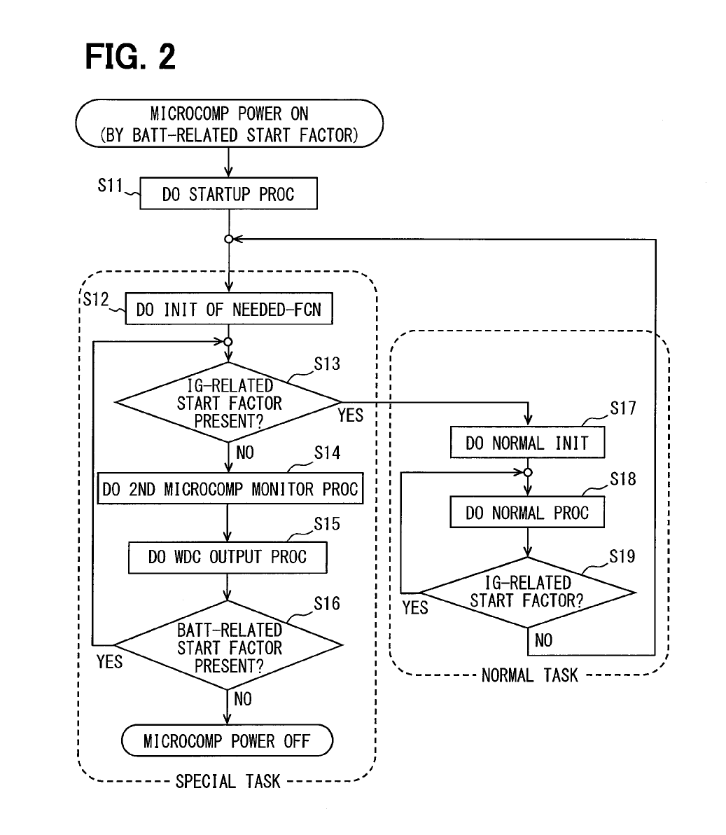

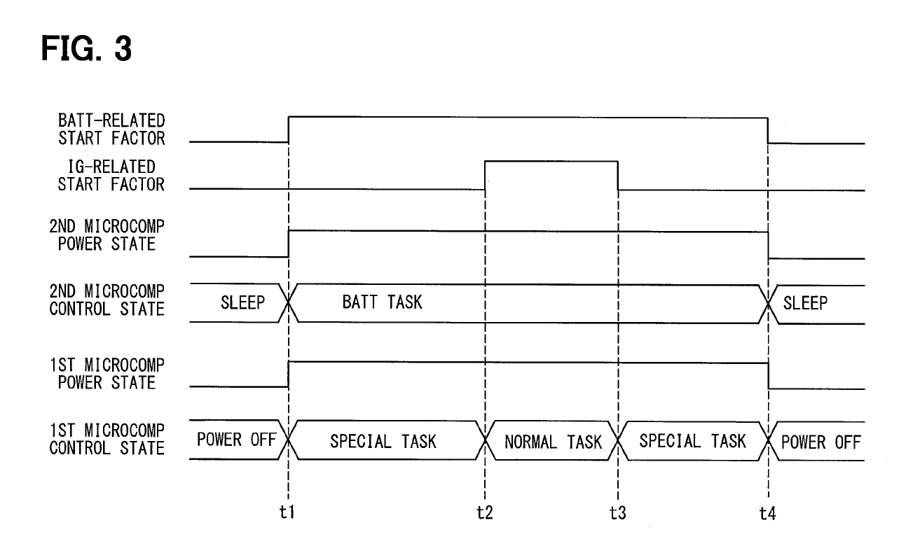

Now, processing of the ECU 100 will be described with reference to FIGS. 2 and 3. When the BATT related starting factor is inputted at the timing t1 of FIG. 3, the first microcomputer 10 and the second microcomputer 20 of the ECU 100 are supplied with the microcomputer power. In other words, the microcomputer power for the first microcomputer 10 and the second microcomputer 20 is turned on. As shown in FIG. 3, a first microcomputer power state, which is the microcomputer power state of the first microcomputer 10, is placed in an on state. Likewise, a second microcomputer power state, which is the microcomputer power state of the second microcomputer 20, is placed in an on state. It is noted that before the timing T1, the first microcomputer 10 is not supplied with the electric power and is thus in a power off state. Before the timing t1, the second microcomputer 20 is in a sleep state.

The first microcomputer 10 starts processing illustrated in FIG. 2 when the supply of the microcomputer power starts. Specifically, the first microcomputer 10 executes the special task 12 when the supply of the microcomputer power starts.

At S11, the first microcomputer 10 executes a startup process. The first microcomputer 10 executes initialization of the I/O (input/output) depending on a circuit element inside the ECU 100.

At S12, the first microcomputer 10 executes an initialization process to initialize the necessary function. Specifically, the first microcomputer 10 executes the restricted initialization process 12a. More specifically, the first microcomputer 10 executes an initialization process to configure an AD conversion function for the IG monitor process 12b, an interruption function for the second WDC monitor process 12c, and a timer function for the first WDC output process 12d.

At S13, the first microcomputer 10 determines the presence or absence of the IG-related starting factor. By executing the IG monitor process 12b, the first microcomputer 10 determines the presence or absence of the IG-related starting factor. The first microcomputer 10 monitors the voltage of the IG power. When the voltage of the IG power exceeds a threshold, the first microcomputer 10 regards this situation as the presence of the IG-related starting factor, and the processing proceeds to S17. When the voltage of the IG power does not exceed the threshold, the first microcomputer 10 regards this as the absence of the IG-related starting factor and the processing proceeds to S14. That is, when the voltage of the IG power exceeds the threshold, the first microcomputer 10 switches over from the special task 12 to the normal task 11. When the voltage of the IG power does not exceed the threshold, the first microcomputer 10 continues executing the special task 12.

At S14, the first microcomputer 10 executes a second microcomputer monitor process. By executing the second WDC monitor process 12c, the first microcomputer 10 determines whether or not the second microcomputer 20 is normally operating. When it is determined that the second microcomputer 20 is not normally operating, the first microcomputer 10 resets the second microcomputer 20.

At S15, the first microcomputer 10 executes a WDC output process. By executing the first WDC output process 12d, the first microcomputer 10 outputs the first WDC.

At S16, the first microcomputer 10 determines the presence or absence of the BATT related starting factor. When the first microcomputer 10 determines the presence of the BATT related starting factor, the processing returns to S13. When the first microcomputer 10 determines the absence of the BATT related starting factor, the processing of FIG. 2 is ended. In the above, the first microcomputer 10 determines the presence of the BATT related starting factor by determining whether or the microcomputer power is supplied. When it is determined that the microcomputer power is supplied, the first microcomputer 10 regards the present situation as the presence of the BATT related starting factor. When it is determined that the microcomputer power is not supplied, the first microcomputer 10 regards the present situation as the absence of the BATT related starting factor. In this way, the first microcomputer 10 repeats S13 to S15 during the presence of the BATT related starting factor.

Thereafter, when the IG related starting factor is inputted at the timing t2 in FIG. 3, the first microcomputer 10 of the ECU 100 makes a determination result YES at S13. That is, at the timing t2 where the IG related starting factor is inputted, the first microcomputer 10 determines that the voltage of the IG power exceeds the threshold, and the processing proceeds to S17. Accordingly, the first microcomputer 10 starts the normal task 11.

At S17, the first microcomputer 10 executes a normal initialization process. That is, the first microcomputer 10 executes the normal initialization process 11a. Specifically, the first microcomputer 10 reads the data needed for the HV control process 11e from the EEPROM 60 and starts a driver needed for communications with an external ECU and the second microcomputer 20. It is noted that the before executing S17, the first microcomputer 10 has already executed the initialization process at S12, which configures the AD conversion function, the interruption function and the timer function

At S18, the first microcomputer 10 executes a normal process. Specifically, the first microcomputer 10 executes the second WDC monitor process 11c, the first WDC output process 11d, the HV control process 11e or the like. At S19, the first microcomputer 10 determines the presence or absence of the IG related starting factor. By executing the IG monitor process 11b, the first microcomputer 10 determines the presence or absence of the IG related starting factor. The first microcomputer 10 monitors the voltage of the IG power. When the voltage of the IG power exceeds a threshold, the first microcomputer 10 regards this situation as the presence of the IG-related starting factor, and the processing returns to S18. When the voltage of the IG power does not the threshold, the first microcomputer 10 regards this situation as the absence of the IG-related starting factor and the processing returns to S12. That is, while the voltage of the IG power exceeds the threshold, the microcomputer 10 continues executing S18.

Thereafter, when the IG related starting factor disappears at the timing t3 in FIG. 3, the first microcomputer 10 of the ECU 100 makes a determination NO at S19. That is, at the timing t3 where the IG related starting factor disappears, the first microcomputer 10 determines that the voltage of the IG power is below threshold, and the processing returns to S12. Accordingly, the first microcomputer 10 starts the normal task 11. Accordingly, the first microcomputer 10 starts the special task 12 to switch over from the normal task 11 to the special task 12. As can be seen in the above, during the presence of the BATT-related starting factor, the first microcomputer 10 can monitor the second microcomputer 20.

Thereafter, when the BATT-related starting factor disappears at the timing t4 in FIG. 3 and both the IG-related starting factor and the BATT-related starting factor are absent, the first microcomputer 10 and the second microcomputer 20 of the ECU 100 stop being supplied with the microcomputer power. In the other words, the microcomputer power to the first microcomputer 10 and the second microcomputer 20 are turned off. In this case, as shown in FIG. 3, the first microcomputer power state of the first microcomputer 10 is placed in the off state. The second microcomputer power state of the second microcomputer 20 is placed in the off state. Accordingly, after the timing t4, the first microcomputer 10 is not supplied with the electric power and is thus in the power off state. The second microcomputer 20 is in the sleep state.

In this embodiment, the ECU 100 includes the first microcomputer 10 equipped with the second WDC monitor process 11c and the first WDC output process 11d, and the second microcomputer 20 equipped with the first WDC monitor process 21b and the second WDC output process 21c. Therefore, in the ECU 100, the first microcomputer 10 and the second microcomputer 20 can mutually monitor their operations during a period during which the IG switch is on and the BATT-related starting factor is generated.

Furthermore, in the ECU 100, the first microcomputer 10 is equipped with the second WDC monitor process 12c for monitoring the operation of the second microcomputer 20 in accordance with the BATT related starting factor. That is, in accordance with the start timing of the second microcomputer 20, the ECU 100 also starts the first microcomputer 10. In this timing, the first microcomputer 10 executes a process for monitoring the second microcomputer 20 as the special task 12 independent of the normal task 11. In other words, in addition to the ignition power related function, the first microcomputer 10 is supplied with the microcomputer power in accordance with the BATT-related starting factor and executes the second WDC monitor process 12c. Therefore, in the ECU 100, the first microcomputer 10 can monitor the operation of the second microcomputer 20 during a period during which the IG switch is off and the BATT-related starting factor is generated. For example, the first microcomputer 10 can monitor the operation of the second microcomputer 20 during a period from the timing t1 to the timing t2 and during a period from the timing t3 to the timing t4. Therefore, the ECU 100 can prevent the non-monitored state of the second microcomputer 20.

Without having a monitor circuit capable of monitoring both the first microcomputer 10 and the second microcomputer 20, the ECU 100 can prevent the non-monitored state of the second microcomputer 20. That is, a monitor circuit less expensive than a monitor circuit capable of monitoring both the first microcomputer 10 and the second microcomputer 20 can be adopted as the monitor circuit 30 of the ECU 100. Therefore, the cost of the ECU 100 decreases as compared with a case where the ECU 100 has a monitor circuit capable of monitoring both the first microcomputer 10 and the second microcomputer 20. Moreover, the ECU 100 can prevent the non-monitored state of the second microcomputer 20 without having a monitor circuit monitoring the second microcomputer 20 in addition to the monitor circuit 30. Therefore, the cost of the ECU 100 decreases as compared with a case where the ECU 100 has a monitor circuit monitoring the second microcomputer 20.

The special task 12 includes the first WDC output process 12d. Therefore, in the ECU 100, the first microcomputer 10 and the second microcomputer 20 can mutually monitor their operations during a period during which the IG switch is off and the BATT-related starting factor is generated.

Moreover, by minimizing a function change of the first microcomputer 10, the ECU 100 can facilitate integration of functions even when different power supply systems are integrated or the monitor circuit 30, which is less expensive, is adopted.

Although embodiments have been illustrated, embodiments are not limited the above illustrated embodiments and modifications thereof. That is, the above embodiments and modifications thereof may be modified in various ways without departing from the spirit and scope of the present disclosure.

What is claimed is:

1. A vehicular electronic control unit, comprising:
a first microcomputer that is equipped with an ignition power related function that is executed in accordance with turn on of an ignition switch and stopped in accordance with turn off of the ignition switch; and
a second microcomputer that is equipped with a battery power related function that is executed in accordance with generation of a starting factor and stopped in accordance with stop of the starting factor, wherein the starting factor is a starting factor that is generated before the turn on of the ignition switch and stopped after the turn off of the ignition switch,
wherein the first microcomputer includes:
a first monitoring unit that, in executing the ignition power related function, monitors an operation of the second microcomputer; and
a first monitored unit that, in executing the ignition power related function, makes the second microcomputer monitor an operation of the first microcomputer,
wherein the second microcomputer includes:
a second monitoring unit that, in executing the battery power related function, monitors the operation of the first microcomputer; and
a second monitored unit that, in executing the battery power related function, makes the first microcomputer monitor the operation of the second microcomputer,
wherein the first microcomputer is equipped with, in addition to the ignition power related function,
a third monitoring unit that monitors the operation of the second microcomputer in accordance with the generation of the starting factor.

2. The vehicular electronic control unit according to claim 1, further comprising
a monitor circuit that monitors the operation of the first microcomputer,
wherein the first monitored unit makes both the monitor circuit and the second microcomputer monitor the operation of the first microcomputer.

3. The vehicular electronic control unit according to claim 1, further comprising
an initialization unit that executes an initialization in accordance with the generation of the starting factor,
wherein the initialization unit executes only the initialization that is needed for the third monitoring unit to monitor the operation of the second microcomputer.

4. The vehicular electronic control unit according to claim 1, wherein:
while the first monitoring unit of the first microcomputer is monitoring the operation of the second microcomputer, the third monitoring unit of the first microcomputer is prohibited from monitoring the operation of the second microcomputer; and
while the third monitoring unit of the first microcomputer is monitoring the operation of the second microcomputer, the first monitoring unit of the first microcomputer is prohibited from monitoring the operation of the second microcomputer.
